(19) United States
(12) Patent Application Publication
(10) Pub. No.: US 2024/0303106 A1
(43) Pub. Date: Sep. 12, 2024

(54) METHOD AND DEVICE FOR TRACKING AND EVALUATING INTERDEPENDENT STATE

(71) Applicant: Haggerty Software LLC, Sherman Oaks, CA (US)

(72) Inventor: John Michael Haggerty, Sherman Oaks, CA (US)

(21) Appl. No.: 18/600,630

(22) Filed: Mar. 8, 2024

Related U.S. Application Data
(60) Provisional application No. 63/489,735, filed on Mar. 10, 2023.

(51) Int. Cl. G06F 9/48; G06F 9/38

(52) U.S. Cl. CPC G06F 9/4831; G06F 9/3838

(57) ABSTRACT

A method of efficiently tracking state data on a computer by designating a class of items called watch objects which have relationships with other data that may change. A change in value in the data which a watch object relies upon causes the execution of a method which efficiently evaluates the watch object and other items which depend on the watch object.

### CROSS REFERENCE TO RELATED APPLICATIONS

This application claims priority to provisional application 63/489,735, filed Mar. 10, 2023, the contents of which are herein incorporated by reference in their entirety.

### TECHNICAL FIELD

Embodiments relate generally to computer programming, and more particularly to efficiently managing state in execution of software on a computing device.

### BACKGROUND

In programs that involve objects with changing attributes, typically the attribute values are described collectively as ‘state.’ State data is required to be computed, stored, and retrieved depending on rules and conditions set by the programmers, and some state needs to affect a program's output in real-time. For instance, the price on a store UI needs to be updated when the user changes the quantity of items they are purchasing. When the functions that compute state are complex and depend on each other, computing output state efficiently and correctly in real time can become challenging and error prone, especially as program requirements change.

### SUMMARY

Described herein is a method and device for effectively tracking and storing interdependent state.

In one embodiment, a method of tracking state data on a computer is described, the method including the steps of initializing an action set, initializing a pending set, wherein the pending set comprises a set of changed watchable data, iteratively determining whether the pending set is empty, and based on a determination that the pending set is not empty, removing an item from the set of changed watchable data, and determining whether the removed item is a watch object. The method may further include, based on a determination that the removed item is a watch object, retrieving a previously computed value of the watch object, computing a new value of the watch object, comparing the previously computed value of the watch object with the new value and based on a determination that the computed value of the watch object has changed or based on the determination that the removed item is not a watch object, may further include adding new dependent items which depend on the removed item to the pending set, removing any dependency links to the new dependent items, removing any watch objects with no dependencies from the pending set and adding all actions to the action set that are triggered when the removed item changes. The method may further include performing each action in the action set. In some embodiments, the actions in the action set are performed once the pending set is empty.

In some embodiments, the method may include assigning a priority order for each item in the pending set wherein removing an item from the pending set is based upon the priority order of each item in the pending set.

In some embodiments, the method may include assigning the priority order based on a computed evaluation cost for the item.

In some embodiments, the assigned priority order for each item is determined by selecting an item, estimating an evaluation cost for the selected item, determining a priority value for each item which the selected item depends on, and creating a priority value for the selected item based on the sum of the evaluation cost of the selected item and the greatest priority value of the items which the selected item depends on.

In some embodiments the method includes creating a dependency link between a dependency and a dependent, determining whether the priority order of the dependent is less than or equal to the priority order of the dependency, and upon a determination that the priority order of the dependent is less than or equal to the dependency, setting the priority order of the dependent to be greater than the priority order of the dependency. In some embodiments, the dependency link is stored in addressable memory. In some embodiments the method includes evaluating the priority order of each subsequent dependent which depends on the aforementioned dependent and adjusting the priority order of a subsequent dependent upon a determination that the subsequent dependent has a priority order that is greater than the aforementioned dependent.

In some embodiments the method includes determining an affected count of an item, wherein the affected count reflects an impact of a change in architecture of a watch graph which includes the item. In some embodiments. the method includes determining that an item with an affected count of 0 has a dependency whose value has changed, and in response to the determination that the dependency has changed, associating a flag with the item.

In some embodiments, the method includes removing any watch objects with no dependencies from the pending set as well as removing watch objects whose only dependencies are other watch objects with no dependencies.

In another embodiment, a device is provided, where the device includes a memory, a processor, and a computer program stored on the memory and operable on the processor, wherein the processor, when running the computer program, is configured to initialize an action set, initialize a pending set, wherein the pending set comprises a set of changed watchable data, iteratively determine whether the pending set is empty, and based a determination that the pending set is not empty, remove an item from the set of changed watchable data, determine whether the removed item is a watch object, based on a determination that the removed item is a watch object, retrieve a previously computed value of the watch object, compute a new value of the watch object, compare the previously computed value of the watch object with the new value, and based on a determination that the computed value of the watch object has changed or based on the determination that the removed item is not a watch object the processor is further configured to add new dependent items which depend on the removed item to the pending set, remove any dependency links to the new dependent items, remove any watch objects with no dependencies from the pending set, and add all actions to the action set that are triggered when the removed item changes. The processor may be further configured to perform each action in the action set. In some embodiments, the processor is configured to perform each action in the action set based upon a determination that the pending set is empty.

In some embodiments, the processor is further configured to assign a priority order for each item in the pending set, where the processor is configured to base its removal of an item from the pending set upon the priority order of each item in the pending set.

In some embodiments, the processor is configured to assign the priority order based on a computed evaluation cost for the item.

In some embodiments, the processor is configured to determine the assigned priority order for each item by selecting an item, estimating an evaluation cost for the selected item, determining a priority value for each item which the selected item depends on, and creating a priority value for the selected item based on the sum of the evaluation cost of the selected item and the greatest priority value of the items which the selected item depends on.

In some embodiments, the processor further is configured to create a dependency link between a dependency and a dependent, determine whether the priority order of the dependent is less than or equal to the priority order of the dependency, upon a determination that the priority order of the dependent is less than or equal to the dependency, set the priority order of the dependent to be greater than the priority order of the dependency. In some embodiments, the dependency link is stored in addressable memory.

In some embodiments, the processor is further configured to evaluate the priority order of each subsequent dependent which depends on the dependent and
adjust the priority order of a subsequent dependent upon a determination that the subsequent dependent has a priority order that is greater than the dependent.

In some embodiments the processor is further configured to determine an affected count of an item, wherein the affected count reflects an impact of a change in architecture of a watch graph which includes the item.

In some embodiments, the processor is further configured to determine that an item with an affected count of 0 has a dependency whose value has changed, and in response to the determination that the dependency has changed, associating a flag with the item.

In some embodiments, the processor being configured to remove any watch objects with no dependencies from the pending set further comprises the processor being configured to remove watch objects whose only dependencies are other watch objects with no dependencies.

### BRIEF DESCRIPTION OF THE DRAWINGS

The components in the figures are not necessarily to scale, emphasis instead being placed upon illustrating the principles of the disclosure. Like reference numerals designate corresponding parts throughout the different views. Embodiments are illustrated by way of example and not limitation in the figures of the accompanying drawings, in which:

FIG. 1 depicts a state graph of an example program, according to an embodiment;

FIG. 2 depicts a watch object graph of an example program, according to an embodiment;

FIG. 3 depicts a simple portion of an example program's watch object graph, according to one embodiment;

FIG. 4A depicts a flow chart illustrating a method for state change management, according to one embodiment;

FIG. 4B depicts the simple portion of a program's watch object graph 300 of FIG. 3 considering FIG. 4A's process 400, according to one embodiment;

FIG. 4C-4E depict the process of the evaluation of state changes, according to one embodiment;

FIG. 5 depicts watch object cost evaluation, according to one embodiment;

FIG. 6A-6C refer to a sequence of watch object graphs with dependency link modifications, according to one embodiment;

FIG. 6D-6G depicts an example watch object architecture as affected by a removed action, according to one embodiment;

FIG. 6H depicts example watch object graphs affected by a change in watch objects after an action is removed, according to one embodiment;

FIG. 7 depicts a threaded watch object graph of a water effect coding example, according to one embodiment;

FIG. 8 depicts a state monitoring solution, according to one embodiment;

FIG. 9 depicts a watch object graph for an example program, according to one embodiment;

FIG. 10, a signal source flowchart of an example program is depicted according to an embodiment;

FIG. 11 depicts a method for tracking and evaluating interdependent state according to an embodiment;

FIG. 12 depicts a block diagram of an exemplary computer system formed with a processor that may include execution units to execute instructions in accordance with embodiments of the present disclosure.

### DETAILED DESCRIPTION

The present disclosure provides systems, devices, and methods used to circumvent the use of complex code to keep track of state data, which is error prone and may involve frequently re-computing the state. For example, in an environment where the price of a shopping cart depends on: the type of items in the cart, the number of items in the cart, whether an item is on sale, whether an item is associated with a coupon, etc, and a current cart total is displayed, a programmer may create instances where the total of the cart is updated in an abundance of locations throughout the code. The embodiments presented below provide an approach to eliminate the programmer's task of recalculating state while still allowing them to use the state wherever and whenever it is needed. The disclosed approaches create state computations whereby unnecessary burdens and any associated unnecessarily high strain on resources of a system may be removed during operation and execution of said complex code.

Embodiments herein depict that by embedding state management into the programming language itself, as opposed to managing state data through written code, the system may enable programmers to simply describe the computation of a state by writing the functions or expressions that compute it, and then receive state change events as needed with minimal recalculation. This involves tracking the interdependencies between the functions as they are executed, caching their computed values, and updating dependent functions whenever a computed value has changed. That is, the present disclosure provides a method which allows a computing device to determine which functions are necessary to run while not running other functions which may not affect a state of a desired object.

The present embodiments provide a method by which coding by a programmer is simplified via a language which stores and automatically recalculates desired data rather than requiring a programmer to write code that does so manually. This increases coding efficiency, by reducing the amount of time a programmer requires to write certain code.

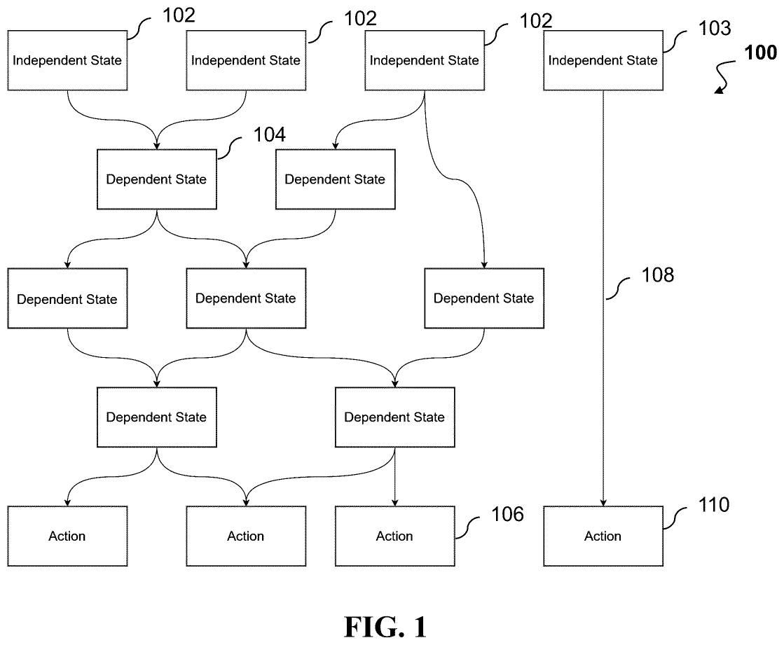

Referring to FIG. 1, an example state graph 100 is depicted. State graph 100 in this example represents the interdependent state in a program oriented in a top-down order. State graph 100 includes independent state nodes 102 which may include many types of data in a program, such as (for example), user input, output from other processes outside the programmer's control, or data that the programmer wishes to set manually. Flowing downward, dependent state nodes 104 represent computable state that depends on both independent state 102 and other dependent states 104. This state may be computed by functions, some of which are more efficient than others, or through other means. Finally, when either independent state 102 or dependent state 104 changes, actions 106 may need to be taken. For example, a program might update its user interface, start a new task, or terminate an ongoing task. State graph 100 illustrates how complex dependencies may affect a program's efficiency in monitoring and maintaining current state values. Independent state 103 directly triggers action 110 without any intermediate dependent states.

Issues which may contribute to the ability of the illustrated executable program to efficiently monitor a state value include: writing of the dependent functions by a programmer, the number of loops that a function may have to run during execution—which could change while running a program, the number of branches or called functions within a function, and the way in which state computation is organized with respect to the state interdependencies. These variables increase the complexity of a system to correctly monitor and accurately compute a state in a real-time environment.

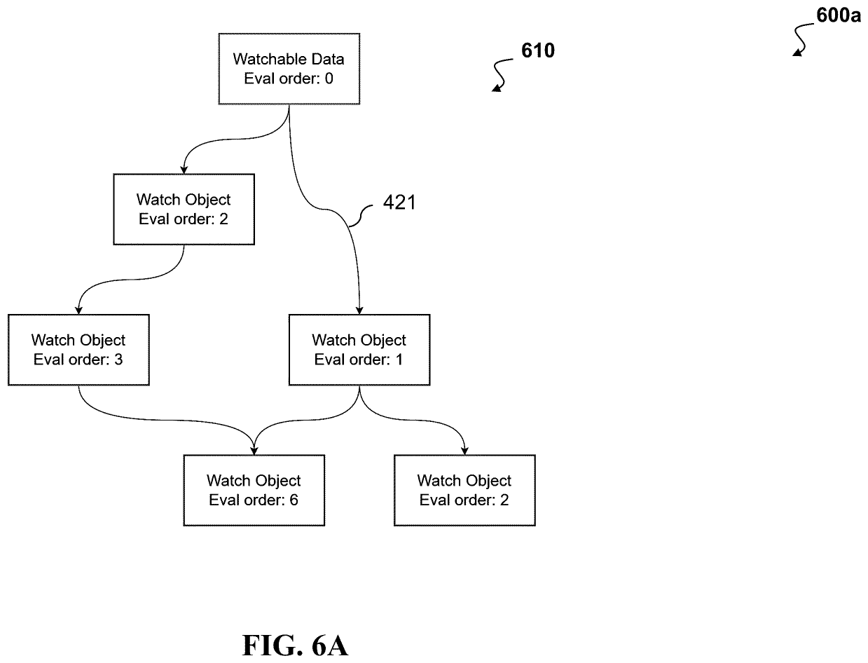

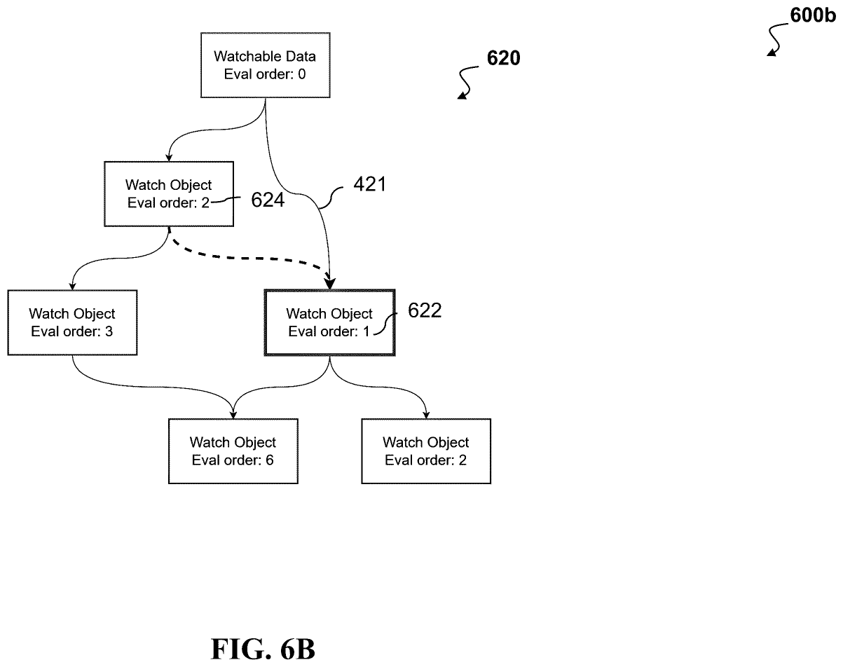

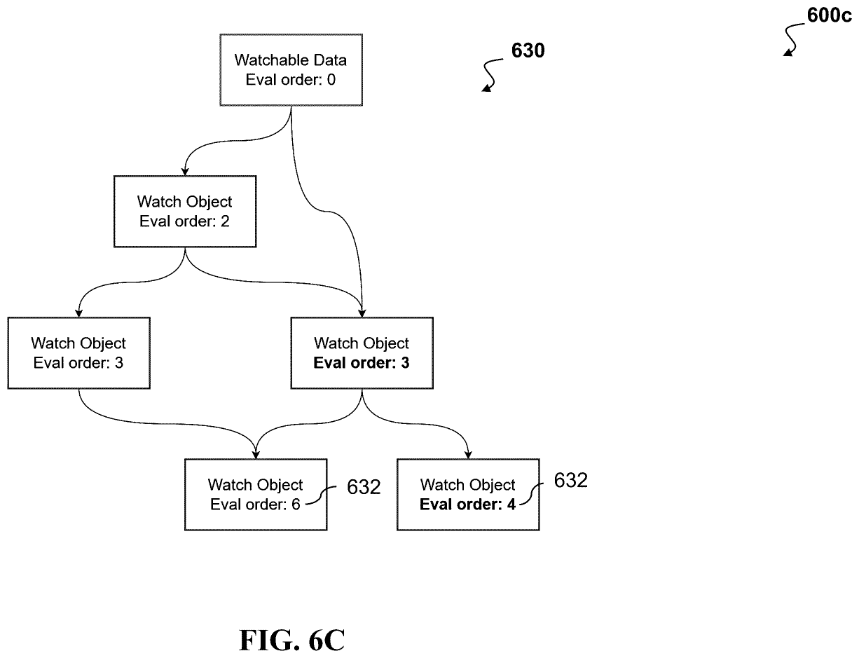

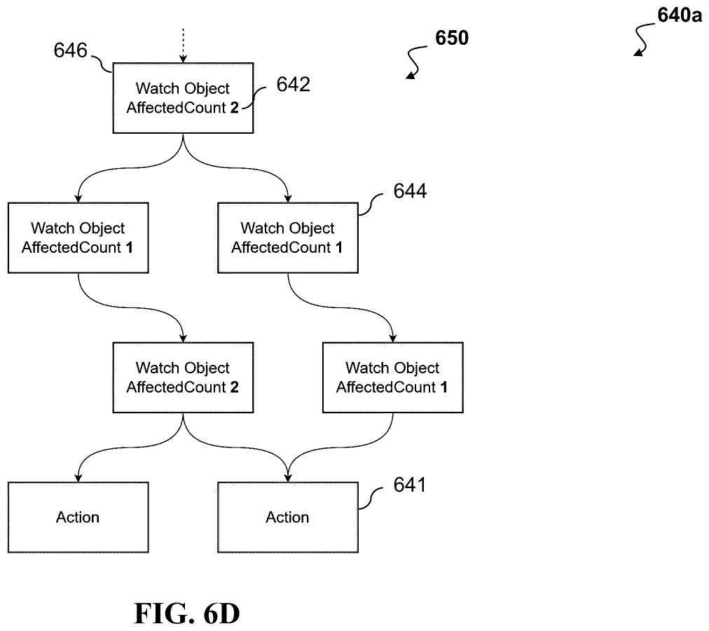

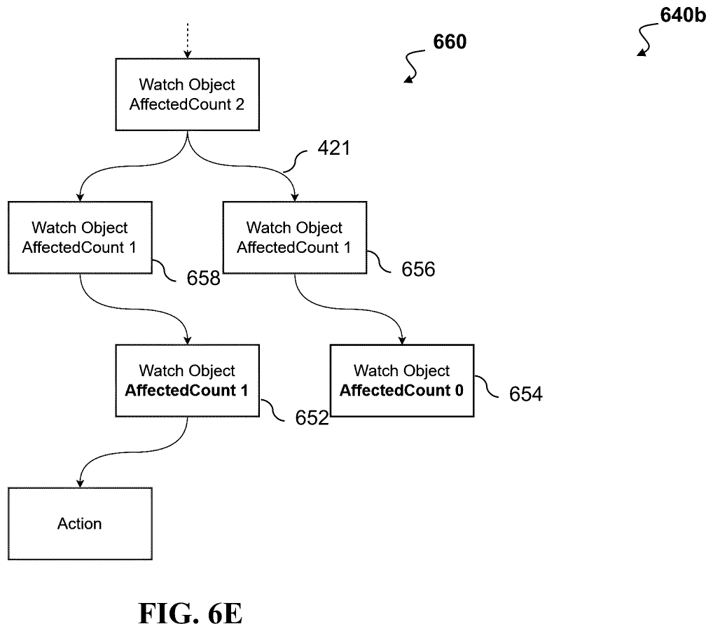

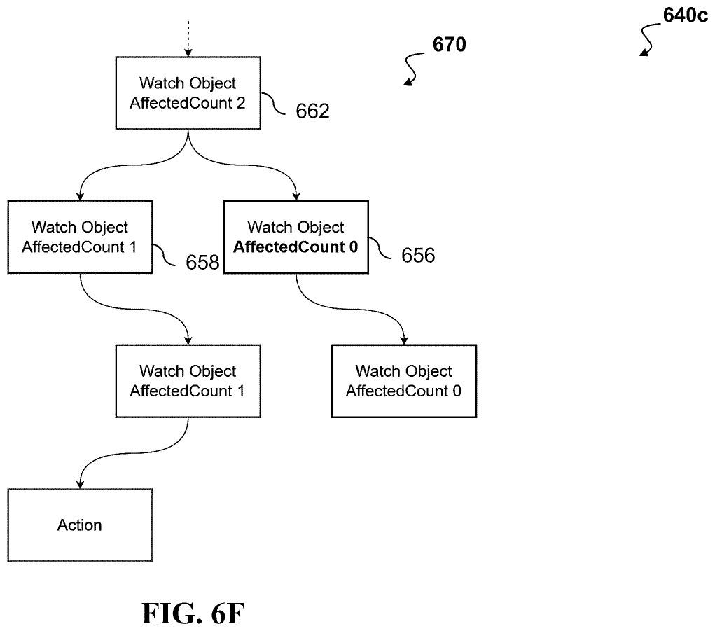

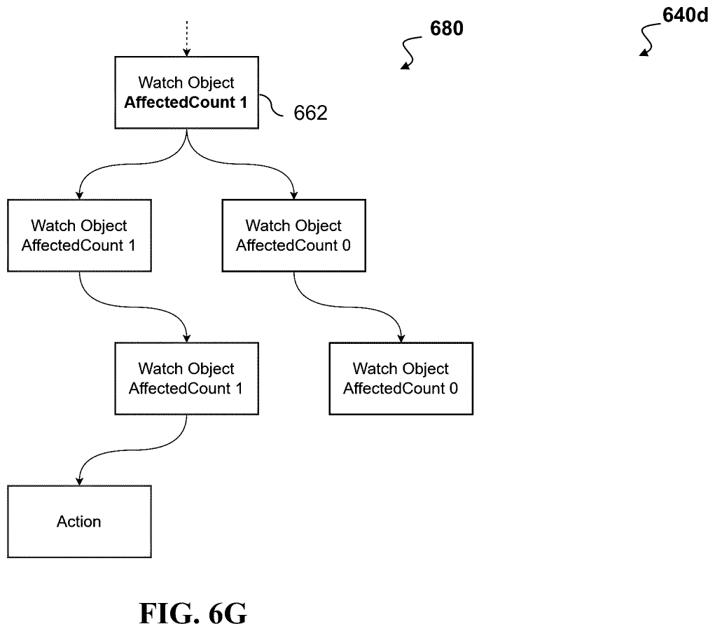

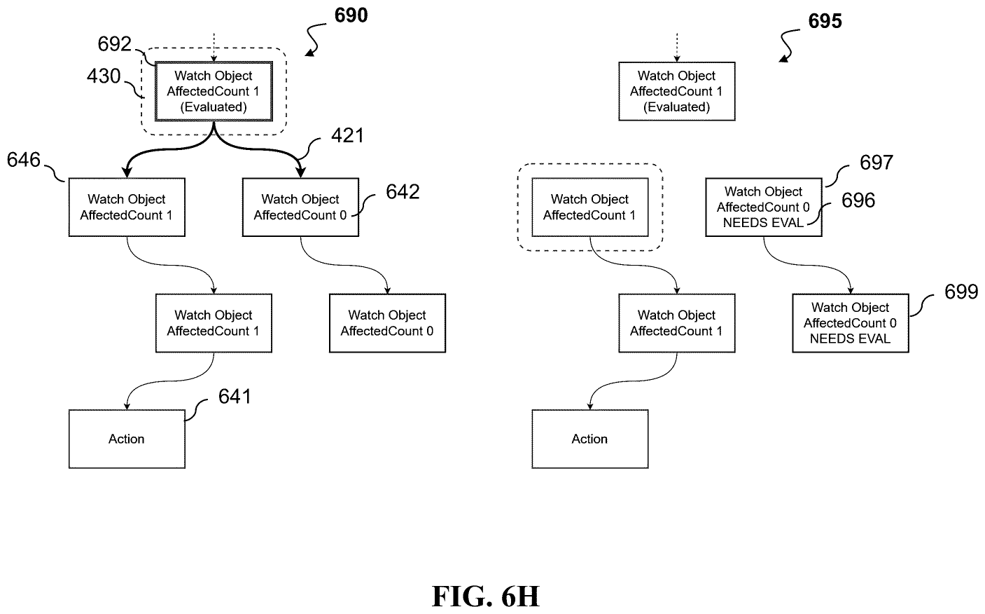

Although a simplified example, the quantity of dependent states in State graph 100 also demonstrates the possibility that intermediate state may have multiple options for order of evaluation, and since both computationally expensive and inexpensive functions may be involved, logic to determine the evaluation order may affect how much work the computer needs to do, as further discussed in FIG. 6 below.

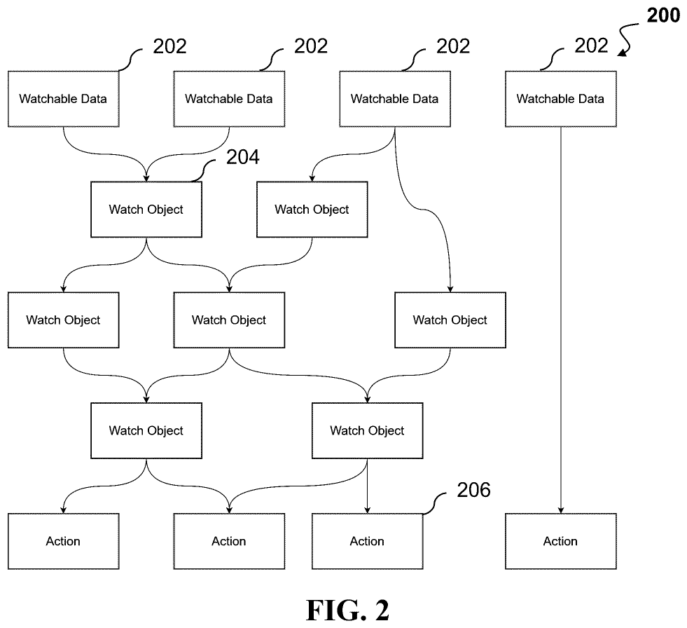

Referring to FIG. 2, an example watch object graph 200 is depicted. Watch object graph 200 in this example represents a model of computation for state graph 100. Watch object graph 200 represents independent state 102 as “watchable data” 202 which may be stored in different ways in a program, such as (for example), global variables, local variables within a function, class members, and “container” types like arrays or maps. “Watchable data” may conceptually be considered as data that may be relied upon by a watch object. Flowing downward, “Watch Object” blocks 204 (middle), short for “Watchable Objects”, represent storage of dependent state 104, as well as storage of the method used to compute that state. Finally, a programmer may attach procedures 206 to be run when some calculated state 204 changes to handle any necessary actions 106 (bottom of FIG. 2).

A watch object may be conceptually considered as a grouping of (a) a method with which a value can be calculated, (b) specific parameter or input values necessary to perform the calculation, and (c) the resulting output value. In some embodiments, a watch object is capable of being associated with the sources of additional input information that is needed during the calculation (such as the result of a function call) and the consumers of the resulting output value in a way that facilitates recalculation when desired. A programmer may identify data as watchable data or identify an object as a watch object to leverage the processes described in the embodiments herein.

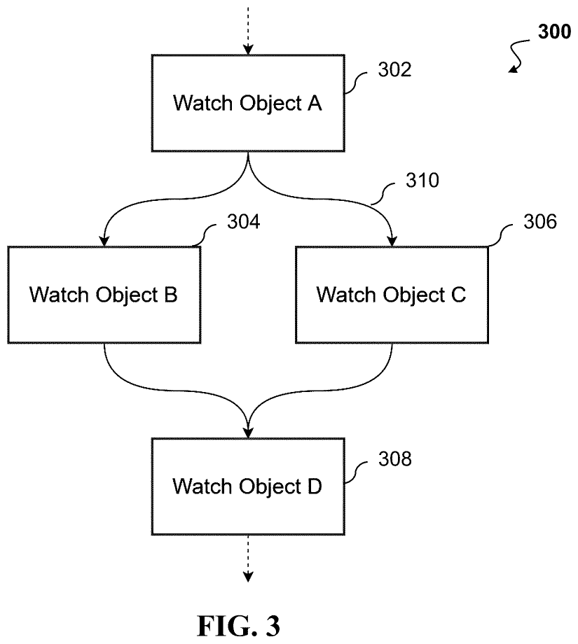

A common example of a watch object is a function call that takes a specific set of argument values. Another example may be a simple counter that increments when any of its dependencies change. Each watch object keeps a cached version of its value to minimize re-computation. Referring now to FIG. 3, when a watch object 304 uses the output of another watch object or uses some watchable data 302 in its calculation, that forms a dependency, depicted as an arrow from the dependency to the watch object that depends on it. These dependencies, when implemented in software, are represented as dependency links, and are a record of a relationship between a pair of items which is utilized to facilitate recalculation of the linked items. An item that is “upstream” from a watch object may be referred to as a dependency while an item that is “downstream” from a watch object may be referred to as a dependent.

In some embodiments, by reevaluating each watch object within a watch object graph, the present disclosure ensures a watch object graph remains acyclic, for easily traversing it in order of dependencies, and for preferring to call less expensive functions when there are options of what to evaluate first. The present disclosure also ensures that the efficiency of the program is higher than a scenario where the disclosed embodiments are not executed, and contemplates that information within a state graph is handled according to factors such as the burden a function may have on a processor.

An embodiment of the present disclosure provides a feature which determines and assesses an estimation of evaluation time of each watch object, stores those estimated evaluation times of each watch object and evaluates their values according to the estimated evaluation times.

Referring to FIG. 3, a simple portion of a program's watch object graph 300 is depicted in accordance with one embodiment of the invention. Watch object graph portion 300 illustrates four watch objects A 302, B 304, C 306, and D 308, where watch object dependencies 310 illustrate by arrows which objects rely on another for data. When a watch object depends on another, for instance as B 304 depends on A 302, a reference may be held in the reverse direction, e.g., B 304 holds a reference to A 302. This reference may be used with reference counting or “garbage collection” to keep A 302 from being deallocated as long as B 304 continues to rely on its value. Similarly, C 306 holds a reference to A 302, and D 308 holds references to B 304 and C 306.

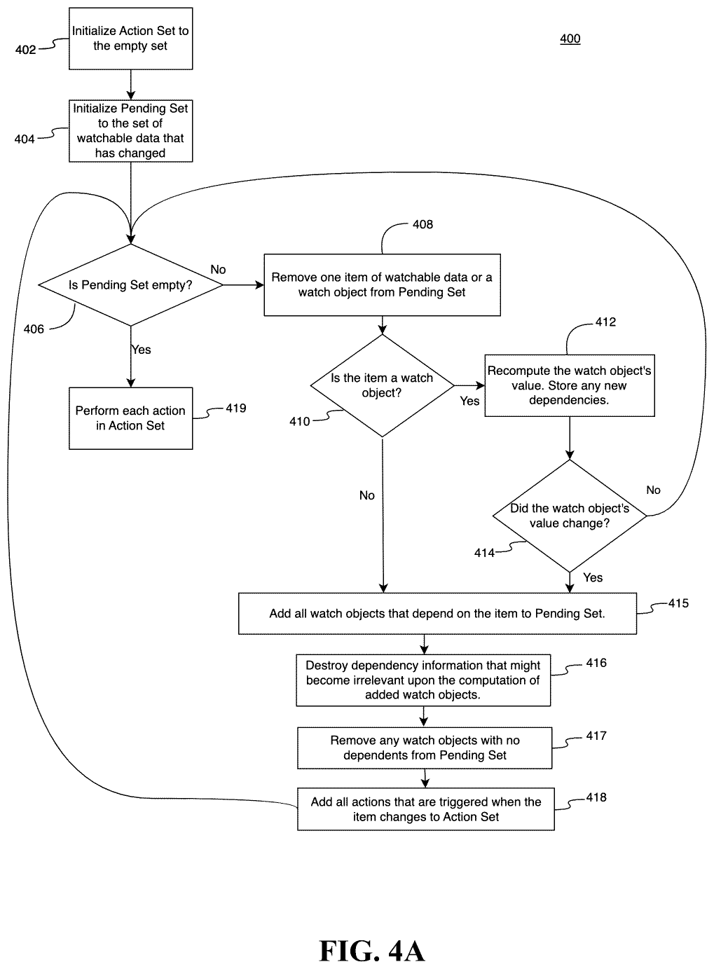

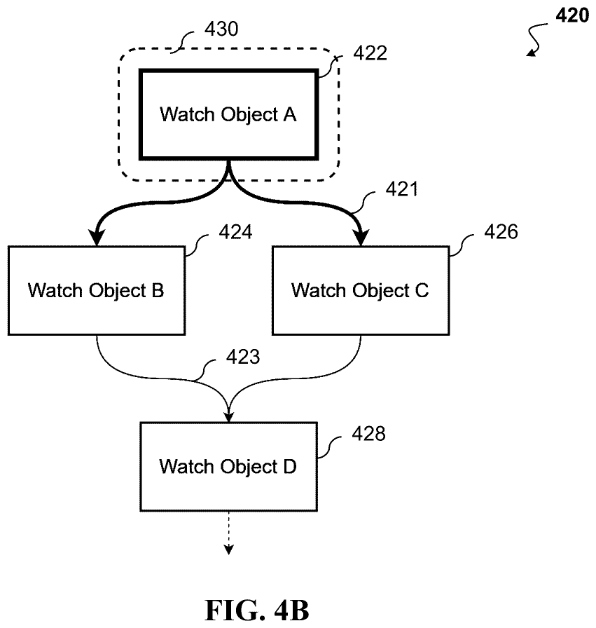

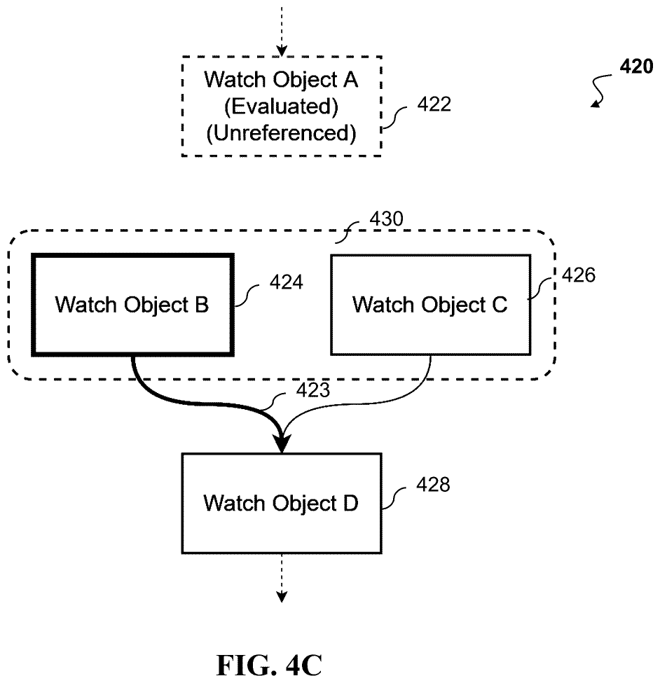

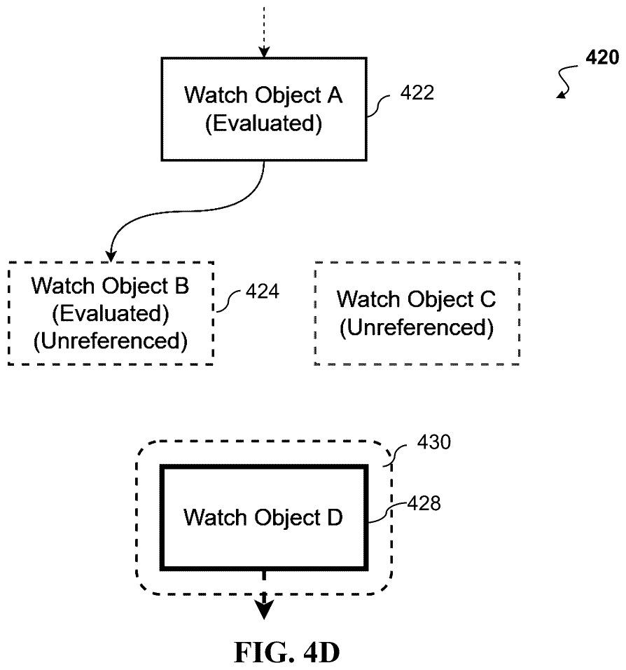

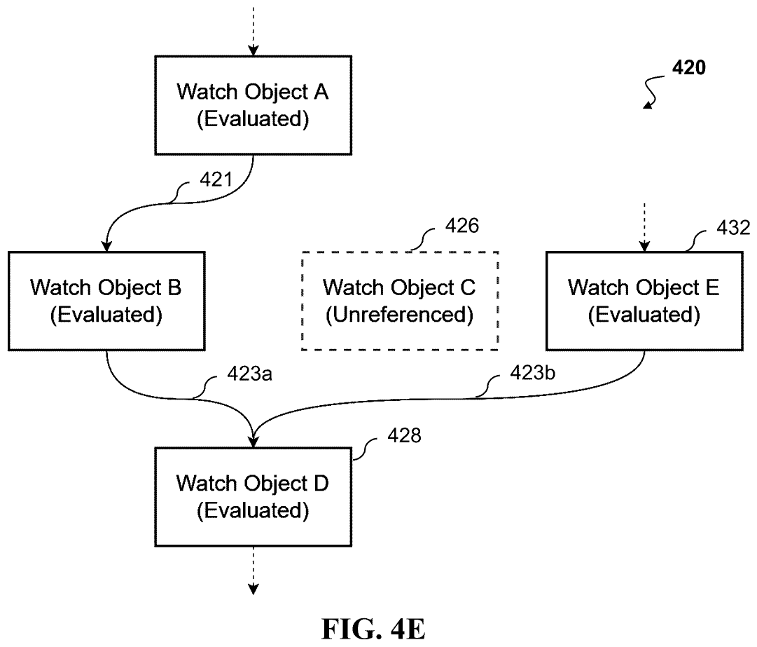

FIG. 4A depicts an example of process 400, which may be used as reference for FIGS. 4B-4D. Process 400 depicts an approach to evaluating state considering factors such as: whether the state is a watch object 410 (as opposed to watchable data), whether the state has changed 414, and whether a dependency is an action (step 418). Process 400 manages dependency links 415, establishing them during reevaluation and destroying them when adding their dependents to a pending set 404.

Particularly, process 400: initializes an action set (step 402), initializes a pending set to a set of changed watchable data (step 404); evaluates whether the pending set is empty (step 406), repeatedly removes an item from the pending set 408; and determines whether the removed item is a watch object 410. If the item is a watch object, process 400 reevaluates the removed item and stores any new dependencies at step 412. The process then determines if the watch object's value has changed at step 414. If the value has not changed, the process returns to step 406 to determine if the pending set is empty. If the watch object's value has changed, or if it was determined at step 410 that the item was not a watch object, the process adds all watch objects that depend on the item to the pending set at step 415. The process destroys dependency links between the added watch objects and all their dependencies that may become irrelevant upon the computation of the added watch objects at step 416. This may leave some watch objects with no dependents, a scenario which is discussed in more detail in FIG. 6. At step 417, any watch objects with no dependents may be removed from the pending set. In some embodiments, such watch objects that are in the pending set may be ignored upon discovery rather than being removed proactively. Additionally, watch objects which have dependents that are functionally irrelevant (i.e., watch objects with an affected count of 0, as discussed in connection FIG. 6) may be removed from the pending set. At step 418, all actions that are triggered when the item changes are added to the action set. After step 418, the process returns to determining whether the pending set is empty. Once the pending set has been emptied through repeating the subprocess beginning at step 408, process 400 continues by performing each action in the action set. In some embodiments, actions in the action set may be performed even though the pending set is not empty. For example, in some embodiments, the actions may be performed as they are found in step 418 rather than being held in the action set.

In the depicted embodiment, the “pending set” is a set of all items of watchable data that are to be evaluated. The “action set” is a set of actions to be performed after all evaluations have been completed.

Referring to FIG. 4B the simple portion of a program's watch object graph 420 of FIG. 3 is depicted considering FIG. 4A's process 400. Simple watch object graph 420 illustrates a scenario in which watch object A 422 has been determined to need reevaluation, which may cause further reevaluation of watch object A's 422 dependents 424, 426, and so on. As an initial step, watch object A is put into a “Pending” set 430 (dotted line area). When watch object A 422 is added to a pending set 430, all incoming dependency links (not shown) for watch object A 422 are destroyed or deleted.

Referring to FIG. 4C, an item is then removed from the pending set 430, in this case watch object A 422, and its new value is evaluated. If watch object A's 422 computed value has changed, its dependencies (watch object 424, 426) are added to the pending set 430 which may also require destroying their respective dependency links 421 (no longer shown) from watch object A 422.

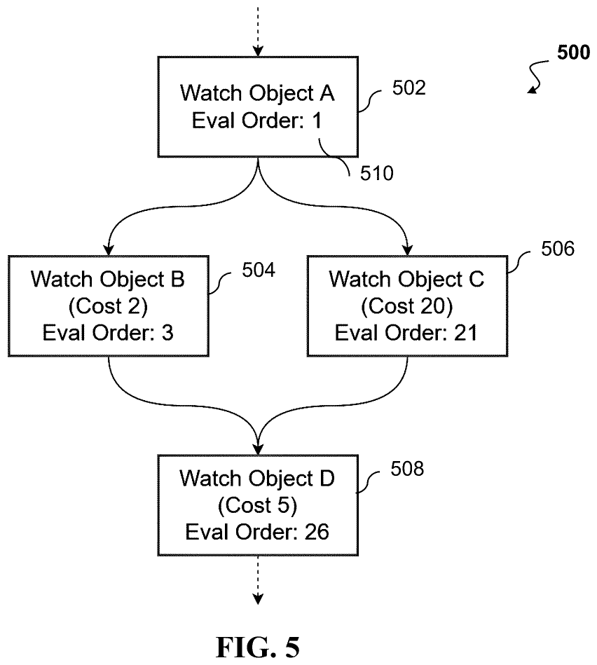

In some embodiments, when more than one item is present in pending set 430 (as depicted in FIG. 4C), different approaches may be applied to determine the order of evaluation (e.g., an estimated cost to evaluate, or a number of dependencies). Cost evaluation is further discussed below in relation to FIG. 5. In some embodiments, the reevaluation of a pending set 430 item involves running a separate function. If watch object A's 422 computed value has changed, its dependencies (watch object 424, 426) are added to the pending set 430 which may also require destroying their respective dependency links 421 (no longer shown) from watch object A 422.

Referring to FIG. 4D, watch object B 424 from FIGS. 4B-4C is removed from the pending set 430 and its value is evaluated. In some embodiments, while a watch object value is being evaluated, it is likely a previous watch object value may be required. When this is confirmed, the dependency link 421 from watch object A 422 to B 424 is reinstated. If watch object B's 424 value has changed, its dependent watch object D 428 may be added to the pending set 430. When D is added to the Pending set, its dependency links 423 are also destroyed, which removes the only references to both watch objects B 424 and C 426.

Continuing to FIG. 4E, watch object C 426 is removed from the pending set 430 because it no longer has any references 423. Additionally, watch object D 428 is also removed from the pending set 430 and evaluated. In some embodiments, as it is evaluated, it may still request the value of watch object B 424, which reinstates the dependency link 423a from watch object B 424. If, in similar scenarios, due to a change in watch object B's 424 value, it no longer needs watch object C's 426 value, it may instead request the value of another watch object E 432. This causes the creation and evaluation of watch object E 432 and creates a dependency link 423b from watch object E 432 to watch object D 428 (During E's evaluation, it may also establish its own dependency links from other watch objects or watchable data.). If watch object D's 428 value has changed, its dependents are then added to the Pending set and the process continues.

When the state evaluation process is complete, objects with no remaining references (such as watch object C 426) may be destroyed or kept in a cache as desired in case their values are needed again. In some embodiments, an external system that monitors, tracks, relies upon, or otherwise utilizes the value of a watch object may hold its own references to it, preventing its destruction.

In some embodiments, it may also be possible to evaluate multiple watch objects in a pending set 430 in parallel, although careful handling is necessary when the evaluation of one watch object in the pending set 430 requires the evaluated value of another.

FIG. 5 depicts watch object cost evaluation graph 500, according to one embodiment. Evaluation graph 500 illustrates one way in which the present disclosure may determine which watch object to remove from a pending set when multiple objects are in the set. Included in evaluation graph 500 are watch objects A-C (502-508) as depicted in FIG. 4B. Accordingly, when a watch object has multiple dependencies, and they all are in the pending set (as watch object D 508 depends on both watch objects B 504 and C 506), it may be preferable to first evaluate the cheapest object in the pending set, because this may prevent the evaluation of one or more other objects in the pending set in a case where they lose their references.

In some embodiments, each watch object is given an “evaluation order” value 510, with the requirement that each watch object's evaluation order is greater than its dependencies'. The watch object with the lowest evaluation order of the pending set is then prioritized first. Each watch object's evaluation order may be set, for instance, to the highest evaluation order of its dependencies plus an estimated cost of the time it may take to evaluate the watch object. As a result, cheaper functions have lower evaluation orders and are preferred to be evaluated first. As shown in the diagram 500, watch objects B 504 and C 506 both depend on A 502, but because C 506 has a cost of 20 and B 504 only has a cost of 2, B's 504 evaluation order is set to a lower value.

In other embodiments, a priority may include simply picking the cheapest function from the pending set, which may result in evaluating watch objects before their dependencies when both are in the pending set. In this embodiment, this method may be suitable if the dependencies are evaluated recursively and handled as they are evaluated (by adding their dependents to the pending set and removing themselves from the pending set as usual).

This inclusion of each function's evaluation cost allows a program to efficiently evaluate states within a program and allows real-time tracking of those states to be more efficient.

FIG. 6A-6C refer to a sequence of watch object graphs 600a-600c, according to one embodiment, where sequence 600a-600c illustrates an example of how an initial watch object architecture FIG. 6A changes according to changes in dependency links 421.

System 600a-600c shows how an evaluation order may also be used to ensure that a watch object graph has no cycles. The first diagram 610 is an example watch object graph architecture including six watch objects arranged in an arbitrary order with arbitrary dependency links 421. When a dependency link 421 is created, as in diagram 620, the present embodiment checks if the evaluation order 624 of the dependency is less than the evaluation order of the dependent 622. In this case it is not (2>1). To correct this, the present disclosure sets the evaluation order 622 of the dependent higher (diagram 630), and then ensures that its dependents' evaluation orders 632 are higher than itself. This involves a search through the graph 630. If the search reaches either of the original watch objects, a cycle is detected.

FIG. 6D-6G depicts example watch object graphs 640a-640d as affected by a change in the watch object graph architecture, according to one embodiment. FIG. 6D depicts a watch object graph 650 including various watch objects 646 arranged arbitrarily with arbitrary dependency links 421 between them. FIGS. 6D-6G further illustrate actions 641 (or lack thereof) at the bottom of the architectures being altered (added/removed). Each watch object 646 also includes an affected count 642 which represents how a watch object 646 is affected by a change in the architecture.

For example, when actions 641 are added to and removed from the watch object graph (650-680), an “affected count” 642 of the dependency (a watch object linked to and above the dependent watch object or action) watch objects 646 are incremented and decremented by 1 respectively. (This can be separate from the reference count of the watch objects if they are referred to from elsewhere, such as a variable in the program.) In some embodiments, the affected count 642 may be evaluated recursively.

Generally speaking, when an action 641 is added, the affected count 642 of its dependencies is incremented. If those watch objects' affected count 642 changed from 0 to 1, the affected count of their dependencies would be incremented. Similarly, when an action 641 is removed, the affected count of its dependencies is decremented.

For example, action 641 of graph 650 is removed in graph 660. Accordingly, the affected counts of dependencies 652 and 654 are decremented by 1 resulting in an affected count of 1 for watch object 652 and 0 for watch object 654. If, for example, any of the dependencies (652 and 654) went from 1 to 0, as does 654 in graph 660, the affected count 642 of their dependencies (656) would also be decremented as illustrated in graph 670.

Referring to FIG. 6G, watch object 662 affected count 642 is ultimately affected and decremented from a 2 to a 1 in a cascading effect resulting from the removal of action 641 of graph 650.

In some embodiments, the affected count 642 is also decremented or incremented when a dependency link 421 from a watch object to another with a nonzero affected count is destroyed or created. This can cause affected count to change during graph evaluation.

FIG. 6H depicts example watch object graphs 690 and 695 as affected by a change while they contain watch objects with an affected count of 0, according to one embodiment. Watch object graphs 690 and 695 depict a watch object graph depicted in FIG. 6G again including various watch objects 646 arranged arbitrarily with arbitrary dependency links 421 between them. Watch object graphs 690, 695 further illustrate actions 641 (or lack thereof) at the bottom of the architectures. Each watch object 646 also includes an affected count 642 which represents how a watch object 646 is affected by a change in the architecture.

Referring to watch object graph 690, when a dependency of a watch object 646 with an affected count of 0 changes, in this example dependency watch object 692, the watch object is not inserted into the pending set 430. Instead, the watch object 697 is marked as “out of date” or “needing evaluation,” 696 (as depicted in watch object graph 695) and all of its dependents 699 (and their dependents, etc.) are recursively marked, depicted in watch object graph 695. In another embodiment, rather than recursively marking a watch object and all of its dependents, watch objects may be marked iteratively or by other processes that would be apparent to one of skill in the art. By precluding a dependent from entering a pending set 430, it avoids unnecessary evaluations of watch objects 646 since it is known that no actions 641 can result from any changes to those watch objects. If the value of a “needs eval” 696 watch object 646 is requested at a later time, it may be recalculated at that time. In some embodiments, the creation or reestablishment of dependency links 421 may further occur accordingly.

In some embodiments, if a watch object's affected count 642 is set to 0 when it is already in the pending set 430 (see discussion of FIG. 4), it may be removed from the pending set 430 and immediately marked with “needs eval” 696 recursively, as above, or through similar methods which would be apparent to one of skill in the art.

TABLE 1
watchable bool fn Want WaterEffects( )
{
return In Water( ) && InThirdPerson( )
}

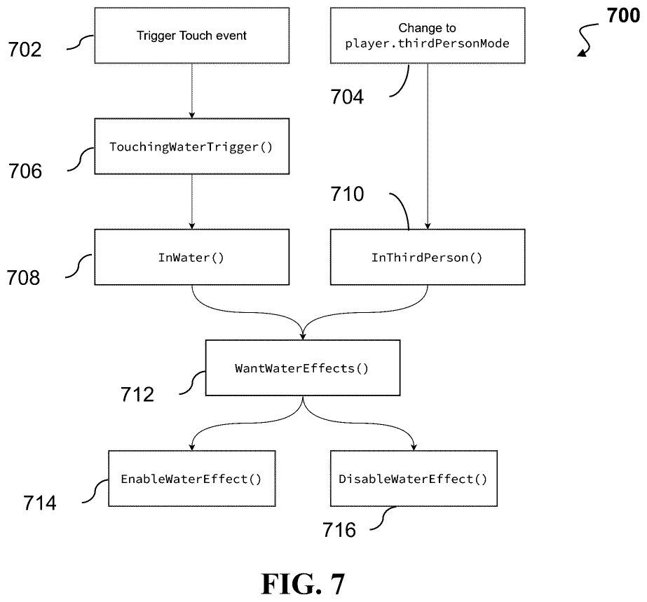

Referring to FIG. 7, a threaded tree diagram of the water effect coding example of Table 1 is depicted.

Table 1 provides a WantWaterEffects function labeled with a “watchable” keyword, an InWater function, and an InThirdPerson function. In the water effect coding example, a state of whether an object is in a water environment is dictated by InWater function and a state of whether the object is displayed in a third person view by function InThirdPerson. Water effect coding example, using the watchable label, may, using the present disclosure, store the returned value data of WantWaterEffects, InWater, and InThirdPerson into addressable memory.

FIG. 7 further depicts the water effect coding example Table 1, in a threaded tree diagram of the water effect coding example 700. The threaded tree diagram 700 includes a TouchingWaterTrigger function 706, where TouchingWaterTrigger 706 depends on a Trigger Touch event 702. Tree diagram 700 illustrates how an object's state can be associated with other state variables and events so that they are recalculated when necessary to determine the value of a function call. InThirdPerson function 710 depends on whether a user has changed to a third person view, where data is received from any change to player.thirdPersonMode variable 704. Tree diagram 700 illustrates where state changes are determined, stored in memory and ultimately calculate whether water effects should be displayed or not at WantWaterEffects 712. The present disclosure interacts with ‘threading controls’, in this example, to actively enable and/or disable a water effect as depicted at EnableWaterEffect 714 and DisableWaterEffect 716 depending on the state of WantWaterEffects 712. Because of the watchable label for the function WantWaterEffects (listed in Table 1), the present disclosure watches the data in all the functions and propagates state changes as needed.

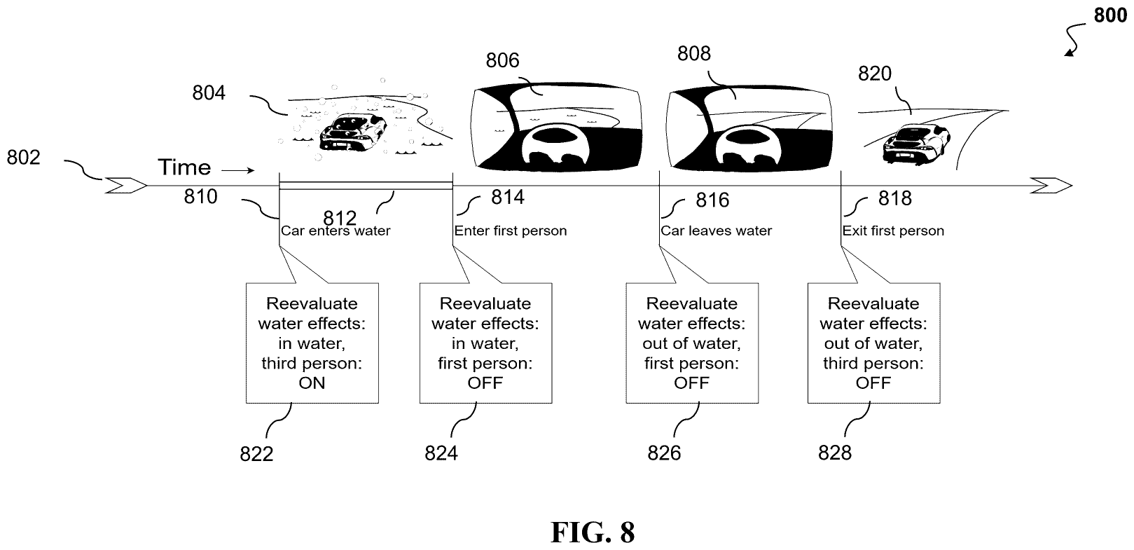

Referring to FIG. 8, a second example of a state monitoring solution in action 800 is depicted according to one embodiment, where a timeline 802 is used as reference for event and state changes.

Below timeline 802 a first state change 810 represents an instance where a program vehicle enters a wet environment, and a reevaluation of a state 822 occurs simultaneously. Reevaluation of state 822, under the conditions ‘in water’, and ‘third person’, the result is an ‘on’ state. In water duration 812 represents a period where WantWaterEffects( ) returns true based on timeline 802, and so a graphical representation depicting water droplets 804 is correctly displayed.

At a second state change 814 a player enters a first-person perspective and a corresponding reevaluation of state 824 simultaneously occurs due to a change of the value of InThirdPerson( ) 710. As depicted an in-water duration 812 ends when a second state change 814 occurs and a first-person perspective is graphically depicted showing an environment without third-person water effects (an ‘off’ state) (as shown in thumbnail 806).

In a third state change 816 a vehicle exits a wet environment and a reevaluation of state 826 occurs returning an ‘out of water’ and ‘first person’, resulting in an ‘off’ state (as shown in thumbnail 808).

At a fourth state change 818, a player selects a third-person perspective, where a reevaluation of state 828 occurs returning ‘out of water’ and ‘third person’ resulting in an ‘off’ state. Accordingly, a graphical representation shows a third-person perspective 820 in a dry environment (i.e., without water effects).

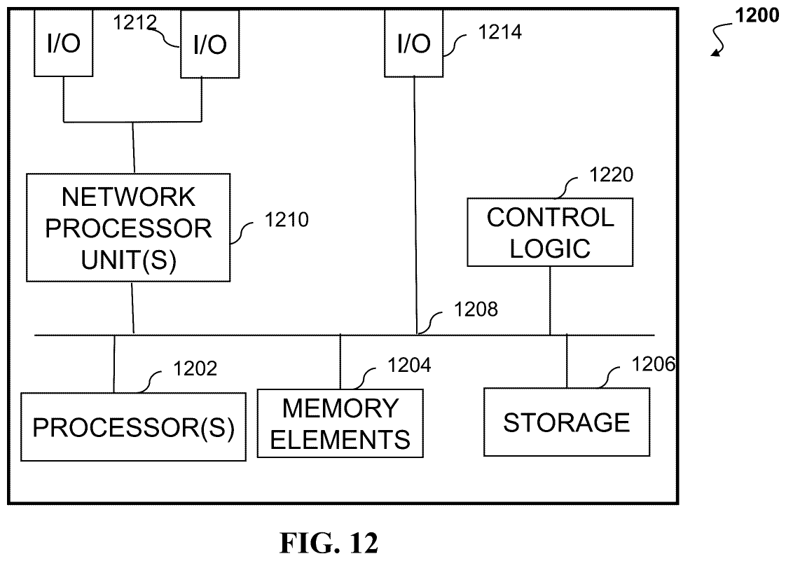

In the second example solution 800 of FIG. 12, a method is used where a function that reevaluates the water effect state 822 is called whenever any of the related conditions change. The present disclosure automatically tracks every condition that can require a reevaluation, precluding an event for human error, such as when a programmer fails to appropriately account for a particular condition.

```
TABLE 2
class Drone
{
      string name
      const watchobj< vector > pos
}
watchable timeval time
const watcharray< Drone > drones
watchable bool fn outer Drone::IsInZone( )
{
  ctconst vector zonePos = <0,0,0>
  ctconst float zoneRadius = 10
  float dist = Distance( this.pos, zonePos )
  return dist < zoneRadius
}
watchable bool fn AllDronesInZone( )
{
  foreach ( drone in drones )
  {
    if ( !drone.IsInZone( ) )
      return false
  }
  return true
}
maywait fn Simulate( )
{
  drones.push(
    Drone {
      name = “A”,
      pos = watchexpr <sin( pi * 0.5 + time * 0.22 ) *
      14, 0, 0>, // back and forth
through and past the zone
      ...
    }
  )
  drones.push(
    Drone {
      name = “B”,
      pos = watchexpr <0, 100 / float(1 + time), 0>, //
      approach zone, enter it and
stay there
      ...
    }
  )
  drones.push(
    Drone {
      name = “C”,
      pos = watchexpr <0, cos( sqrt( time * 2.0 ) ) *
      14, 0>, // back and forth
through and past the zone, slower over time
      ...
    }
  )
  waitfor AllDronesInZone( )
}
```

Referring to Table 2, an example drone movement program code is listed. Drone movement program code simulates the movement of a set of drones and waits until all of the drones are in a given circular zone (defined in member function Drone::IsInZone( ) by providing zonePos and zoneRadius). Each drone's position (pos) is stored as a watch object whose value is an <X,Y,Z> position in 3D space. The “watchable” function “Drone::IsInZone( )” calculates whether a drone is in the circle defined by zonePos and zoneRadius. The “watchable” function “AllDronesInZone( )” calculates whether all of the drones in the “watcharray” “drones” are in the calculated zone, by calling their aforementioned IsInZone( ) method. A watcharray is an array which can be watched for changes (e.g., if contents are added, removed, or reordered); that is, an array for which the size and order can be treated as watchable data. The “Simulate( )” function initializes three drones with functions that depend on the “watchable” variable “time”, and then waits until AllDronesInZone( ) returns true. The “time” variable and the “drones” watcharray are examples of watchable data. Resuming the Simulate( ) function is an example of an action that can result from changes to watchable data.

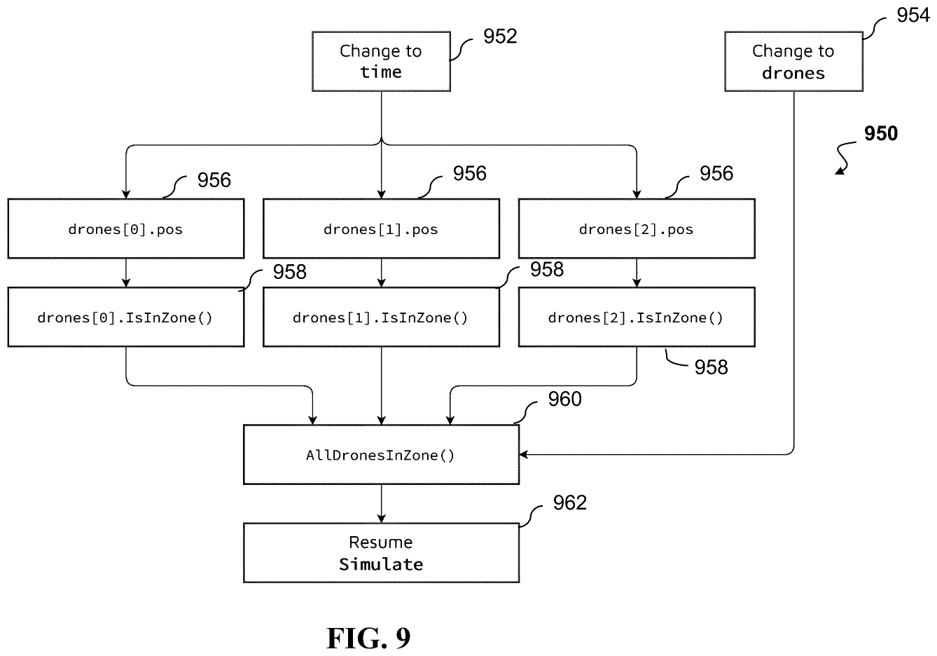

Referring to FIG. 9, a “watch object graph” 950 is depicted. The program tracks the location of three objects, Drones (0), (1), and (2), and whether they are within the boundary of an area called the ‘Zone’. Over a period of time, the drones constantly move throughout a space which includes the Zone. The watch object graph 950 tracks the states of each drone, and if all of the drones are within the boundary of the Zone at the same time, a function is triggered.

Example watch object graph 950 further includes a watchable variable 952, where the watchable variable 952 represents a variable holding a time value which affects drone “pos” watch objects 956 and drone IsInZone( ) function calls 958. The watch object graph 950 illustrates watch objects representing calls to those functions which may affect an object's state, such as in this program whether a drone is within Zone. The watch objects in the graph and their relative dependencies are represented by data in memory and, in some embodiments, may be constructed dynamically as AllDronesInZone( ) is called and the values of the above function calls are computed.

As stated previously, dependency watch objects drones.pos 956 provide a position coordinate of a drone at a given time, as computed by their “watchexpr” functions in Simulate( ). Function AllDronesInZone 960 is calculated using dependent function calls 958 as illustrated and describes whether all dependent drone locations are within the designated zone region.

Drones watch object graph 950 further includes Drones watcharray 954, where watcharray 954 is linked to AllDronesInZone 960. Here code (not illustrated) that manipulates watcharray 954 is connected to cause reevaluation of AllDronesInZone 960. In some embodiments, when functions are marked as watchable, all calls to the watchable functions including the parameters passed are stored in addressable hashes. In Drones watch object graph 950, when the contents of watcharray 954 changes, according to the present disclosure, AllDronesInZone 960 function is reevaluated and links to AllDronesInZone 960, such as links from drone IsInZone 958, are severed and then reconnected, as function(s) drone.IsInZone 958 are re-executed. Accordingly, interdependent links to drone.IsInZone 958 may also be severed and reevaluated. This feature of the present disclosure provides a method of updating a Boolean value of AllDronesInZone 960, for example, so that dependent actions such as a resume action 962 are triggered with more reliable and efficient calculations in a real-time environment.

In the embodiment depicted in FIG. 9, watch objects Drones[0, 1, 2].IsInZone 958 are separate instances of a single function Drone::IsInZone( ) written by the programmer. Accordingly, the only differences between the different watch objects 958 are the arguments (Drones) they're called with.

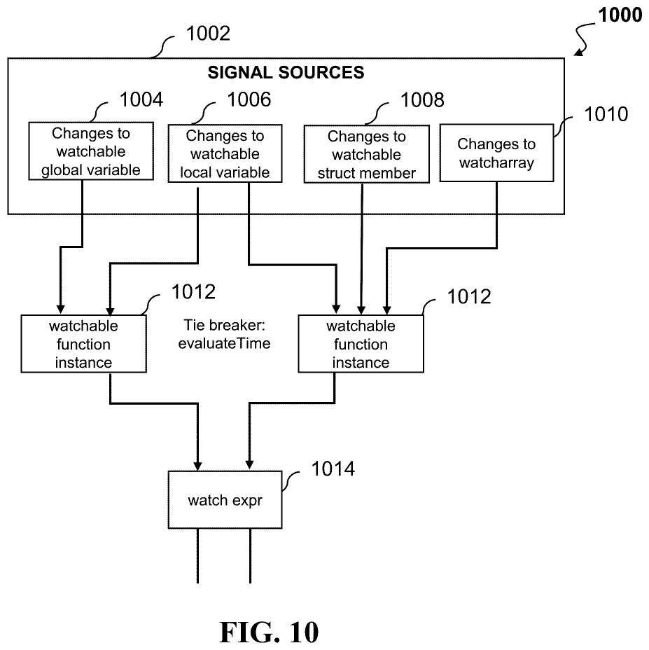

Referring to FIG. 10, a signal source flowchart 1000 of an example program is depicted according to an embodiment. Included in the signal source flowchart 1000 are signal sources 1002, where signal sources 1002 represent a set of watchable data with dependent watchable function instances 1012. Watchable function instances are a type of watch object that represent a function call with specific arguments. Within the signal sources set 1002 are a change to watchable global variable 1004, a change to watchable local variable 1006, change to watchable structure member 1008, and change to watcharray 1010. These signal sources 1002 are the arguments to dependent watchable function instances 1012, and can “signal” them to reevaluate when the source data changes. As structured, watchable function instances 1012 further affect watchable expression 1014. A “watchable expression” is a type of watch object that represents the evaluation of an expression, whose inputs can be watchable data, watchable function instances, or other watch objects, as illustrated in Table 2 with the “watchexpr” keyword.

When the signals are sent to reevaluate watchable function instances 1012, their evaluation order (as described in FIG. 5) can be used as a tie breaker, if necessary, to determine which to evaluate first. If the first one evaluated evaluates to a new value, watch expression 1014 will be added to the Pending set, and its dependency on the other watchable function instance will be destroyed, resulting in its removal from the Pending set, preventing re-evaluation of the more expensive function.

According to the disclosure, using features highlighted above, state data is managed in a more efficient manner where signal sources 1002 provide signals to watchable functions 1012 where management of interdependent function links, for example, create a signal flow 1000, where 1) dependency mapping may be simplified, 2) function execution may be managed more efficiently ensuring that unnecessary executions of functions are minimized, and 3) program coding may also be simplified.

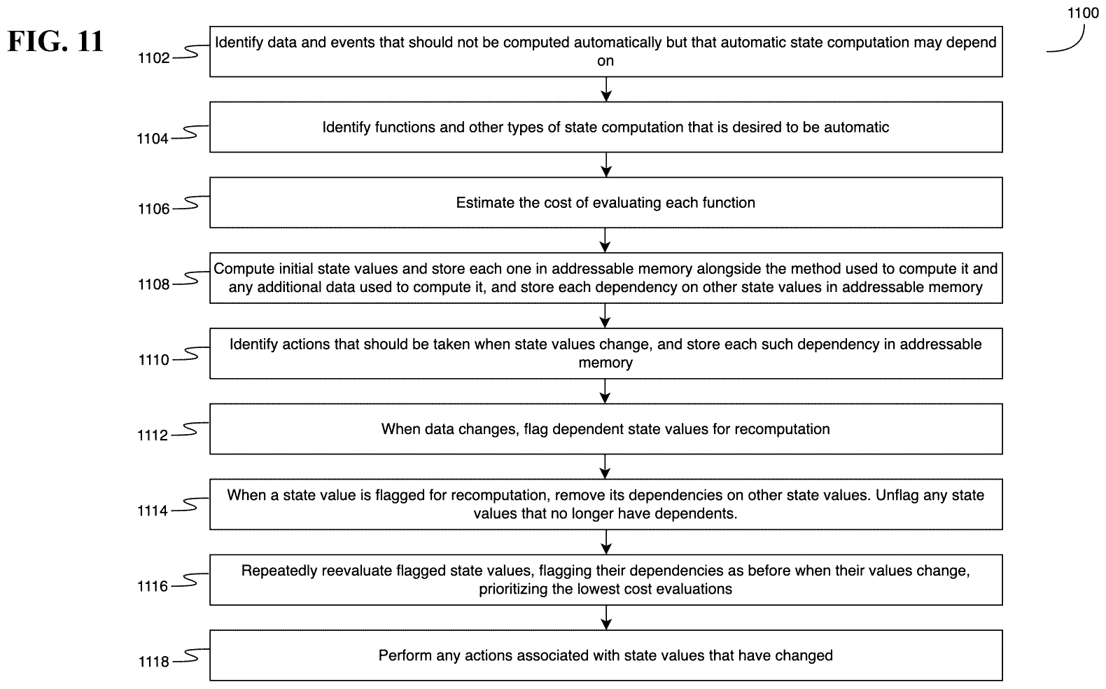

Referring to FIG. 11, a method for tracking and evaluating interdependent state 1100 is depicted according to an embodiment of the present disclosure. Accordingly, at step 1102, the method first identifies data and events that do not need automatic computation but that automatic computation of other state may depend on, and then at step 1104 identifies data for which automatic computation is desired. At step 1106 an evaluation cost is estimated for each function, wherein a value is assigned to the function according to a multitude of factors. In some embodiments these factors may comprise one or more of: a number of operations performed and a number of loops within the function. In other embodiments, these factors may comprise an indirectly measured function time. In other embodiments, an evaluation cost may include a measured computer burden value. In yet another embodiment the evaluation cost is within a finite range. In another embodiment, the range may be between 0 and 128. In a later step 1108, when state values are needed, they are computed and each dependency on other state values is also stored in addressable memory. Each state value may be stored in addressable memory alongside the method used to compute them (such as a watchable function, for example) and any additional data used to compute them (such as arguments to the function). In some embodiments, the state values may be stored in a hash table indexed by the method and additional data. In a next step 1110, actions that must be taken when state values change also have their dependencies on those state values stored in addressable memory. When previously identified data (from either steps 1102 or 1104) changes, in step 1112, the dependencies are used to flag state values that need recomputation. When a state value is flagged for recomputation, as in step 1114, its dependencies on other state values are removed. In some embodiments, state values that no longer have dependents are unflagged. In step 1116, the flagged state values are evaluated and, if their values change, dependent state values are also flagged as above. Evaluation order may prioritize lower cost functions as was estimated in step 1106. Finally, in step 1118, any actions that are associated with state values that changed are taken.

In other embodiments after the updated object state is stored, all links from other parent functions are removed and no other functions linked to the watchable item are executed.

Referring to FIG. 12, FIG. 12 illustrates a hardware block diagram of an exemplary computing device 1200 that may perform functions associated with operations discussed herein in FIG. 1-11. In various embodiments, a computing device, such as computing device 1200, or any combination of computing devices 1200, may be configured as any entity/entities as discussed for the techniques depicted in connection with FIG. 1-11 in order to perform operations of the various techniques discussed herein.

In at least one embodiment, computing device 1200 may include one or more processor(s) 1202, one or more memory element(s) 1204, storage 1206, a bus 1208, one or more network processor unit(s) 1210 interconnected with one or more network input/output (I/O) interface(s) 1212, one or more I/O interface(s) 1214, and control logic 1220. In various embodiments, instructions associated with logic for computing device 1200 can overlap in any manner and are not limited to the specific allocation of instructions and/or operations described herein.

In at least one embodiment, processor(s) 1202 is/are at least one hardware processor configured to execute various tasks, operations and/or functions for computing device 1200 as described herein according to software and/or instructions configured for computing device. Processor(s) 1202 (e.g., hardware processor(s)) can execute any type of instructions associated with data to achieve the operations detailed herein. In one example, processor(s) 1202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor.’

In at least one embodiment, memory element(s) 1204 and/or storage 1206 is/are configured to store data, information, software, and/or instructions associated with computing device 1200, and/or logic configured for memory element(s) 1204 and/or storage 1206. For example, any logic described herein (e.g., control logic 1220) can, in various embodiments, be stored for computing device 1200 using any combination of memory element(s) 1204 and/or storage 1206. Note that in some embodiments, storage 1206 can be consolidated with memory element(s) 1204 (or vice versa), or can overlap/exist in any other suitable manner.

In at least one embodiment, bus 1208 can be configured as an interface that enables one or more elements of computing device 1200 to communicate in order to exchange information and/or data. Bus 1208 can be implemented with any architecture designed for passing control, data and/or information between processors, memory elements/storage, peripheral devices, and/or any other hardware and/or software components that may be configured for computing device 1200. In at least one embodiment, bus 1208 may be implemented as a fast kernel-hosted interconnect, potentially using shared memory between processes (e.g., logic), which can enable efficient communication paths between the processes.

In various embodiments, network processor unit(s) 1210 may enable communication between computing device 1200 and other systems, entities, etc., via network I/O interface(s) 1212 (wired and/or wireless) to facilitate operations discussed for various embodiments described herein. In various embodiments, network processor unit(s)1210 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s) and/or other similar network interface driver(s) and/or controller(s) now known or hereafter developed to enable communications between computing device 1200 and other systems, entities, etc. to facilitate operations for various embodiments described herein. In various embodiments, network I/O interface(s) 1212 can be configured as one or more Ethernet port(s), Fibre Channel ports, any other I/O port(s), and/or antenna(s)/antenna array(s) now known or hereafter developed. Thus, the network processor unit(s) 1210 and/or network I/O interface(s) 1212 may include suitable interfaces for receiving, transmitting, and/or otherwise communicating data and/or information in a network environment.

I/O interface(s) 1214 allow for input and output of data and/or information (wired and/or wireless) with other entities that may be connected to computing device 1200. For example, I/O interface(s) 1214 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1220 can include instructions that, when executed, cause processor(s) 1202 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1220) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, and register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1204 and/or storage 1206 can store data, software, code, instructions (e.g., processor instructions), logic, parameters, combinations thereof, and/or the like used for operations described herein. This includes memory element(s) 1204 and/or storage 1206 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

It is contemplated that various combinations and/or sub-combinations of the specific features and aspects of the above embodiments may be made and still fall within the scope of the disclosure. Accordingly, it should be understood that various features and aspects of the disclosed embodiments may be combined with or substituted for one another in order to form varying modes of the disclosed disclosure. Further, it is intended that the scope of the present disclosure is herein disclosed by way of examples and should not be limited by the particular disclosed embodiments described above.

What is claimed is:

1. A method of tracking state data on a computer, the method comprising:
initializing an action set;
initializing a pending set, wherein the pending set comprises a set of changed watchable data;
iteratively determining whether the pending set is empty, and based on a determination that the pending set is not empty:
removing an item from the set of changed watchable data;
determining whether the removed item is a watch object;
wherein, based on a determination that the removed item is a watch object, retrieving a previously computed value of the watch object, computing a new value of the watch object, comparing the previously computed value of the watch object with the new value; and
based on a determination that the computed value of the watch object has changed or based on the determination that the removed item is not a watch object the method further comprises:
adding new dependent items which depend on the removed item to the pending set, removing any dependency links to the new dependent items, removing any watch objects with no dependencies from the pending set, adding all actions to the action set that are triggered when the removed item changes; and
performing each action in the action set.

2. The method of claim 1, the method further comprising:
assigning a priority order for each item in the pending set;
wherein the removing an item from the pending set is based upon the priority order of each item in the pending set.

3. The method of claim 2, wherein the assigning the priority order is based on a computed evaluation cost for the item.

4. The method of claim 2, wherein the assigned priority order for each item is determined by:
selecting an item;
estimating an evaluation cost for the selected item;
determining a priority value for each item which the selected item depends on; and
creating a priority value for the selected item based on the sum of the evaluation cost of the selected item and the greatest priority value of the items which the selected item depends on.

5. The method of claim 2, the method further comprising:
creating a dependency link between a dependency and a dependent;
determining whether the priority order of the dependent is less than or equal to the priority order of the dependency; and
upon a determination that the priority order of the dependent is less than or equal to the dependency, setting the priority order of the dependent to be greater than the priority order of the dependency.

6. The method of claim 5, the method further comprising:
evaluating the priority order of each subsequent dependent which depends on the dependent; and
adjusting the priority order of a subsequent dependent upon a determination that the subsequent dependent has a priority order that is less than or equal to the dependent.

7. The method of claim 1, the method further comprising:
determining an affected count of an item, wherein the affected count reflects an impact of a change in architecture of a watch graph which includes the item.

8. The method of claim 7, the method further comprising:
determining that an item with an affected count of 0 has a dependency whose value has changed, and in response to the determination that the dependency has changed, associating a flag with the item.

9. The method of claim 1, wherein the removing any watch objects with no dependencies from the pending set further comprises removing watch objects whose only dependencies are other watch objects with no dependencies.

10. The method of claim 5, wherein the dependency link is stored in addressable memory.

11. A device comprising: a memory, a processor, and a computer program stored on the memory and operable on the processor, wherein the processor, when running the computer program, is configured to:
initialize an action set;
initialize a pending set, wherein the pending set comprises a set of changed watchable data;
iteratively determine whether the pending set is empty, and based a determination that the pending set is not empty:
remove an item from the set of changed watchable data;
determine whether the removed item is a watch object;
based on a determination that the removed item is a watch object, retrieve a previously computed value of the watch object, compute a new value of the watch object, compare the previously computed value of the watch object with the new value; and
based on a determination that the computed value of the watch object has changed or based on the determination that the removed item is not a watch object the processor is further configured to:
add new dependent items which depend on the removed item to the pending set, remove any dependency links to the new dependent items, remove any watch objects with no dependencies from the pending set, add all actions to the action set that are triggered when the removed item changes; and
perform each action in the action set.

12. The device of claim 11, wherein the processor is further configured to:
assign a priority order for each item in the pending set;
wherein the processor is configured to base its removal of an item from the pending set upon the priority order of each item in the pending set.

13. The device of claim 12, wherein the processor is configured to assign the priority order based on a computed evaluation cost for the item.

14. The device of claim 12, wherein the processor is further configured to determine the assigned priority order for each item by:
selecting an item;
estimating an evaluation cost for the selected item;
determining a priority value for each item which the selected item depends on; and
creating a priority value for the selected item based on the sum of the evaluation cost of the selected item and the greatest priority value of the items which the selected item depends on.

15. The device of claim 12, the processor further configured to:
create a dependency link between a dependency and a dependent;
determine whether the priority order of the dependent is less than or equal to the priority order of the dependency;
upon a determination that the priority order of the dependent is less than or equal to the dependency, set the priority order of the dependent to be greater than the priority order of the dependency.

16. The device of claim 15, the processor further configured to:
evaluate the priority order of each subsequent dependent which depends on the dependent; and
adjust the priority order of a subsequent dependent upon a determination that the subsequent dependent has a priority order that is less than or equal to the dependent.

17. The device of claim 11, wherein the processor is further configured to:
determine an affected count of an item, wherein the affected count reflects an impact of a change in architecture of a watch graph which includes the item.

18. The device of claim 17, the processor further configured to:
determine that an item with an affected count of 0 has a dependency whose value has changed, and in response to the determination that the dependency has changed, associating a flag with the item.

19. The device of claim 11, wherein the processor being configured to remove any watch objects with no dependencies from the pending set further comprises the processor being configured to remove watch objects whose only dependencies are other watch objects with no dependencies.

20. The device of claim 15, wherein the dependency link is stored in addressable memory of the device.
